(19) United States
(12) Patent Application Publication
(10) Pub. No.: US 2005/0278641 A1
(43) Pub. Date: Dec. 15, 2005

(54) Javascript Calendar Application Delivered to a Web Browser

(76) Inventors: Steve Mansour, Milipitas, CA (US); Mikol Graves, San Francisco, CA (US)

Correspondence Address: Glenn Patent Group;Suite L, 3475 Edison Way, Menlo Park, CA, 94025, US

(21) Appl. No.: 10/398,084

(22) PCT Filed: Nov. 30, 2000
(86) PCT No.: PCT/US00/32689

§ 371 Date: Mar. 31, 2003

(51) Int. Cl. G09G 5/00; G06F 3/00

(52) U.S. Cl. 715/749

(57) ABSTRACT

The present invention is a calendaring system implemented as a JavaScript application for program execution on individual Internet browsers alter being downloaded by a webserver. The JavaScript application generates HTML on-the-fly and a graphical user interface is displayed on a user's screen. The result is an interactive scheduling system that can be shared between users on the Internet.

### BACKGROUND OF THE INVENTION

1. Technical Field

The present invention relates to web browsers and the Internet, and more specifically to calendar client applications that can run on all computer platforms and that improve calendar-server scalability.

2. Description of the Prior Art

The success of the Internet means that each web server will be Whit on by more and more web browsers. It therefore follows that there is less CPU time available at the web server to handle each visitor. So allowing more than one iteration between a users and server for a single result is a luxury than can no longer be afforded. It also now makes sense to transfer responsibility for any needed processing from the web server to the web browser.

Netscape Calendar is a program that allows users to manage their time more efficiently by maintaining a calendar of a users activities. Users can place items on the calendar as needed in order to stay organized. Netscape Calendar is intended for collaborative use, so each user can access the calendars of other users and plan meetings or other events without phone calls or e-mail messages. Netscape Calendar is a part of Netscape Communicator Professional Edition and needs to activated by an administrator before it can be used. But such conventional system requires far too much support and attention from the web server.

Netscape Calendar includes Agenda, a sharable calendar, tasks, daily notes, and daily events. Netscape Agenda also provides access to the users tasks, daily notes, day events and reminders. Any event scheduled in a users agenda's day, week or month view is an agenda entry. Users can create and view a user's agenda entries and, in some cases, those of others, depending on a user's access rights and the access level the creator has assigned the entry. Users may also edit any entries created in a user's name. Users can create tasks in a user's agenda. Tasks are things users have to do, but that cannot be scheduled into a user's agenda like a meeting or an appointment. Such tasks appear in a task view of a user's daily agenda pages and in a user's task display. Users can create daily notes in a user's agenda. Notes are entered into a user's agenda, not already entered under tasks, day events, or agenda entries. The daily notes appear in the notes view of a user's daily and weekly agenda pages. A day event lasts for an entire day, without taking up time in a user's day view. Day events will appear in the notes view at the bottom of a user's agenda pages.

Netscape Calendar can remind users of the entries users have in it. Such reminders can be set up in a number of different ways, to suit the demands of a user's entries and a user's schedule. Users can print out a user's agenda pages. The different types of pages can be tailored to include only the information users want on a user's printouts. The fonts and margins can also b e adjusted to suit a user's needs.

Each Netscape Calendar server manages a database of individual calendars, the number of which is limited by the capabilities of the server hardware. As with POP/IMAP e-mail mailboxes, individual calendars always sit on the same servers, so each calendar has a “home” server. Calendars also may also exist on a user's local system, and can select any number of calendars to be synchronized onto the local system. When a suitable network connection is available, the local calendars can be synchronized with a server-based calendar database. Users typically synchronize only their own calendar, but Netscape Calendar servers support making local, synchronized copies of any calendar in a system. A user who is traveling could therefore bring along a whole department's calendars. When multiple calendars exist on the same calendar server, free/busy searches can be run on that server. When user's calendars are spread across many servers, a user's home server must connect separately to each server to gather the free/busy information and to present a unified view.

U.S. Pat. No. 5,960,406, issued Sep. 28, 1999, to Rasansky, et al., describes a scheduling system for use between users on the web. Each end user is granted a unique password protected personal calendar. This calendar is generated from information stored in a database at a central server, and delivered to each end user as standard HTML sent through the Internet. This custom personal calendar is then viewed by the end user in a standard Web Browser. This obviates the need for special software programs to be purchased by end users, and also allows end users of any CPU type to read their calendars. When an end user uses the system to send an invitation or announcement to others on the system, the sending end user has the option of sending e-mail in addition to posting that information in the calendars of others. When an end user sends an invitation or announcement to a person who is not an Appointnet user, then the Appointnet system automatically creates a unique calendar for the recipient, and sends an e-mail to that person. Individuals who use the present system can post reminders to themselves, send announcements to people they know, and make appointments with people they know. When these messages are sent, the communication is nearly instantaneous because the system makes one record and allows both (or many) parties to view it. Such patent is incorporated herein by reference.

### SUMMARY OF THE INVENTION

The present invention is a calendaring system implemented as a JavaScript application for program execution on individual Internet browsers after being downloaded by a webserver. The JavaScript application generates HTML on-the-fly from within invisible frames and renders such HTML on a users screen in visible frames. The result is an interactive scheduling, appointment, and calendaring system that can be shared between many users on the Internet.

### BRIEF DESCRIPTION OF THE DRAWINGS

FIG. 1 is a functional block diagram of an Internet calendaring system embodiment of the present invention; and

FIG. 2 is a dataflow diagram of a calendaring system embodiment of the present invention in which a web-server sends frame sets that open in users' browsers as visible and invisible frames.

### DETAILED DESCRIPTION OF THE INVENTION

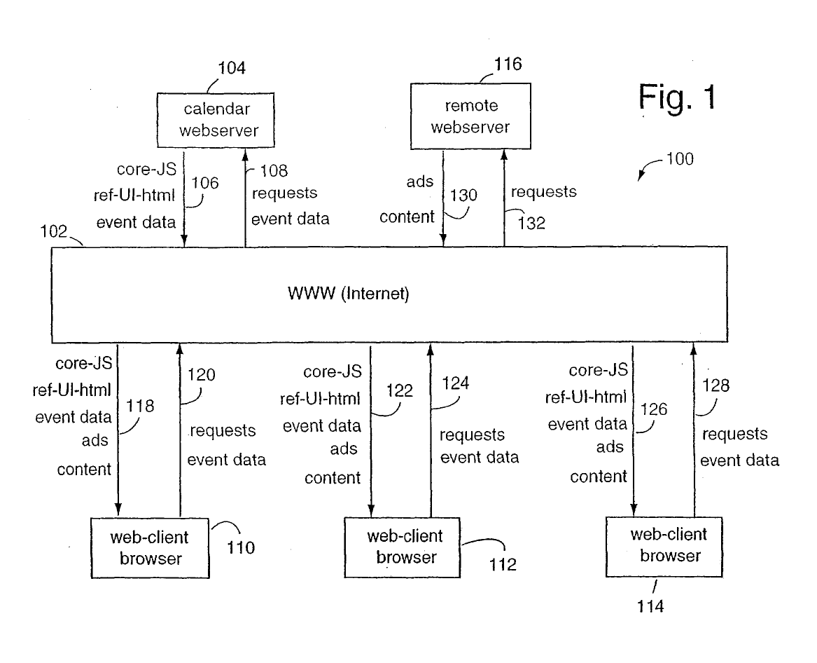

FIG. 1 is a functional block diagram of a calendar system embodiment of the present invention referred to herein by the general reference numeral 100. The Internet 102 is used to interconnect network servers and clients. A calendar webserver 104 provides a shared calendar control and synchronization function for many clients distributed about the Internet. Such clients and users can share and exchange calendar information to help coordinate community events, private meetings, classroom attendance, legal deadline observance, etc. An output 106 transmits hypertext transfer protocol (HTTP) datapackets that include calendar core routines written in JavaScript, for example, reference users interfaces (ref-UI) written in hypertext markup language (HTML), and calendar event data. Such are issued in response to requests and event data received in HTTP datapackets on an input 108. A number of typical web-clients and their browsers are represented by web-clients 110, 112, and 114. The users as such may be independent or loosely associated in a variety of groups and special interests. A remote webserver 116 can include a sponsor who pays a fee to the operator of the calendar webserver 104 to include commercial advertisements in the JS-core, ref-UI, and calendar event data on output 106.

The JS-core, ref-UI, and calendar event data on output 106 are received on an input 118 to web-client 110 in response to requests issued to the calendar webserver 104 over an output 120. The web-client 110 may generate original calendar event data that will be stored in the calendar server and can be distributed to the appropriate users by the calendar webserver 104. Similarly, requested JS-core, ref-UI, and calendar event data on output 106 are received on an input 122 to web-client 112 in response to requests issued to the calendar webserver 104 over an output 124. This web-client 112 may also generate unique and original calendar event data that needs to be distributed to the appropriate users by the calendar webserver 104. The web-client 114 is no different. An input 126 receives JS-core, ref-UI, and calendar event data on output 106. An output 128 handles requests to calendar webserver 104 and any special event data generated. An output 130 from the remote webserver provides advertisements and content in typical HTML and JavaScript http-datapackets. Any requests, e.g., hyperlinks clicked on by users at the web-clients 110, 112, and 114, are received on an input 132.

The web-clients' browsers 110, 112, and 114 must support frames, e.g., multiple windows that can be generated and controlled by the webserver 104. For example, Netscape Navigator 3.0, or later version, will be preferred. The JS-core, ref-UI, and calendar event data on output 106 will initially cause a frame set to be created. Some of the frames in the frame set will be visible to the web-client users, and some will not be visible. Those that are not visible are used to interface the event data on the webserver with the visible frames on the web-client browser. The ref-UI is coded in Javascript within HTML and will build a graphical user interface in a model-calendar format, e.g., days, weeks, months. The JS-core is coded in JavaScript and provides interactive users control locally, e.g., from within one of the non-visible frames. An initial download of event data from the webserver to the web-client will be preferably adequate to service most if not all read-only calendar interactions by a user. Any missing or needed event data will be requested as needed. New, original event data generated by a user that is important for other users to have is uploaded to the webserver 104. Changes to existing event data are uploaded as well.

A web-client user interface is included in the calendar server. A web-client user interface is generated “on-the-fly” within a user's browser. First, a frame set is created. Several frames are visible to the user, and several frames are “hidden” and not visible on the screen. One such frame includes calendar event data that was requested from the server. Other frames include JavaScript routines that know how to read the event data and produce HTML to render the events or other interface elements. The JavaScript running in the hidden frames emit HTML to the visible frames to render the interface seen by the users. As the user presses links and controls on the interface, calls are made into the JavaScript routines to change the interface. For example, if the user presses the month button, the JavaScript routines will emit a monthly calendar view of data and send it to the visible frames.

One advantage to this approach is that a lot of processing is done in a user's browser, and a round trip to the server is not required for every button click. For example, suppose that several months worth of event data is downloaded in one call to the server. Suppose that the user is viewing one day's worth of data. Now the user clicks the “next day” button. It is likely that the event data for the next day is already in the invisible data frame. Assuming it is, the JavaScript routines detect this, and emit the HTML for the next day and display it. There was no need to make a round trip request to the server. The number of requests that the server must process is reduced because many requests can be processed on the web browser by the JavaScript. Furthermore, for users with phone modem connections to the ISP, the new page can be generated much faster than a web page can be transmitted from the server.

Such interface generation allows links to images, ads, or other content to b e accessed from a remote server.

The web-client code is a combination of JavaScript and HTML. It is divided into two major parts, a JS-core and a reference user-interface (Ul). The JS-core includes routines to: (a) fetch, edit, create and delete calendar events, (b) login/logout, (c) import/export calendar information, (d) preference management routines, e.g., agenda list management, initial view, first day of week, time-zone, (e) calendar management routines (WCAP commands), (f) localize strings, (g) change locales, (h) set colors and fonts, (i) set themes (specific combinations of colors, fonts, and logo images), (j) format dates and time zones, and (k) date navigation, date utilities, and interface utilities.

The reference user-interface implements a calendar user interface based on the JS-core routines. Such includes linked events, agendas (layers of calendars), and, public and private calendars. Users can own multiple calendars, and calendars can be owned by multiple users. Links can be embedded in web pages or e-mail messages to point to individual events or calendar views. E-mail alarms, e-mail paging, and e-mail invitations to events are also supported by the calendar web server 104. User preferences typically include preferred first-day-of-week, preferred time zone, multiple time zone support, import/export/synchronization, print preview, deletion tombstones, color scheme, font scheme, sound scheme, and context-sensitive help.

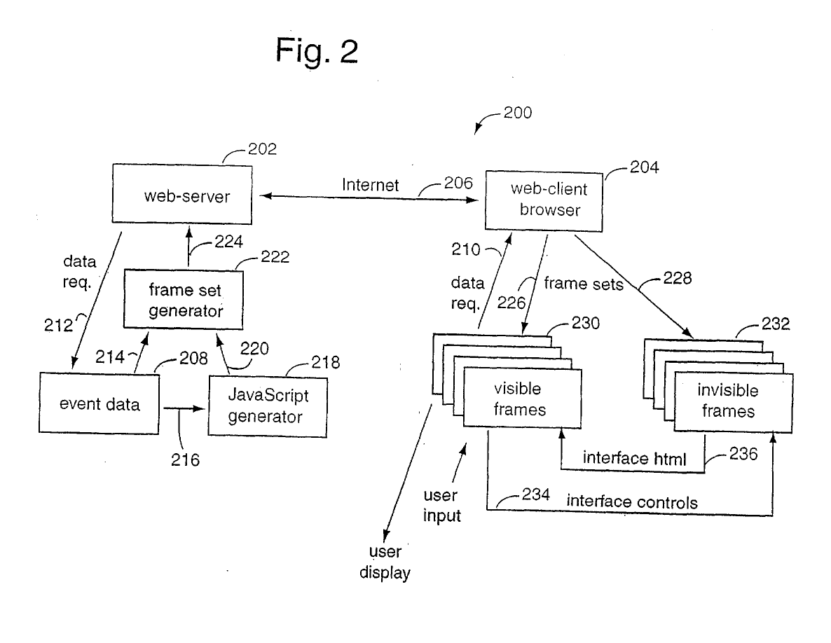

FIG. 2 illustrates a calendaring system embodiment of the present invention, and is referred to herein by the general reference numeral 200. The system 200 is based on a web-server 202 that services at least one web-client 204 over an Internet connection 206. A calendar event database 208 stores coordinated, corrected, and up-to-date calendar information in condensed form. A data request 210 initiated by a browser user at a network client site includes a description of what particular calendar information a user wants. This is forwarded over the Internet 206 and becomes a data request 212. The appropriate data is fetched and its presentation may require certain user interfaces to deal with it.

Therefore, the calendar event database 208 responds to queries with an event data 214 and an event-interface description 216. A JavaScript generator 218 builds corresponding JavaScript routines 220 that will be executed as-needed by the web-client 204. A frame set generator 222 builds a mixed event data, HTML, and JavaScript code 224 for transmission to the web-client 204.

At the web-client 204, such mixed event data, HTML, and JavaScript code is separated into a visible-frames data 226 and an invisible-frames data 228. A frames-capable browser responds with a set of visible frames 230 that appear before the user and a set of invisible frames 232. For example, the visible frames 230 can include day, week, month, and year interactive graphical user interfaces for appointment, event, and schedule data of concern to the user.

The purpose of the invisible frames 232 is to host the downloaded JavaScript routines and calendar data 220. A user-interface control 234 will trigger various ones of the JavaScript routines to execute and generate new user-interface HTML 236 that will render within or build more visible frames 230.

In alternative embodiments of the present invention, a “standalone” or “native” client is needed that has off-line capabilities, sync capabilities, and is feature rich. Traditionally, these clients also had to be developed on multiple platforms (Windows, Mac, and Unix). Such calendar client preferably has entirely downloadable chrome, i.e., the entire user interface look-and-feel can be downloaded to a client that understands a description language such as XML/CSS. It should look, feel, and act like a native client, and actually be an application that makes use of browser/XML/CSS technology.

Some embodiments of the present invention preferably can incorporate attachments to events. A back-end that supports an iCalendar GEO property (geographic event location), is exposed in the interface. Meeting locations are tied to mapping services to allow users to obtain personalized maps and directions to event locations. Layout management tools are preferably included for customizing the interface. Automated operations include adding an extra frame on the top, bottom, or side of each window, and adding links to web address on each page.

A fully functional calendaring system preferably incorporates portions of Netscape Messaging Server. Such enables users to exchange information within a company and across the Internet. Messaging Server is controlled by electronic mail or HTML forms and lets administrators manage users information and system-configuration parameters with the easy-to-use, point-and-click interface of Netscape Navigator and Communicator from any desktop on the network. It offers feature richness without compromising messaging interoperability or standards compliance.

Messaging Server version-3.5 provides numerous feature enhancements over the previous releases, including: Support for Internet Message Access Protocol Version-4 (RFC 1730) to provide messaging support for remote users, including support for IMAP4rev1 (RFC 2060) for optimal performance of message throughput. E.g., integration with the latest release of the frames-based administration of Netscape SuiteSpot 3.1 for centralized administration of all Netscape servers; procedures for doing bulk additions, deletions, and modifications that allow quick migration of existing users. Integrated NIS and NIS+lookup capability is useful to facilitate address resolution outside of Messaging Server's domain.

The SSL 3.0 support in Netscape Messaging Server administration is used for secure remote administration and client communications, and LDAP version-3 support (RFC 2251) for centralized users management, message routing, and international character sets. Authenticated SMTP (to prevent unauthorized Message transmissions) and IMAP over SSL (to fully encrypt communications between the server and the client) are important. Support for delivery status notifications, to determine status of sent messages inside or outside the corporation, and improved network manageability via SNMP and NT EventVwr and Perfmon are included. Support is needed for messaging Internet Foundation Classes, and for creating mail-enabled applications between the client and server. A server application programming interface (API) helps to develop customized transport-enable applications.

Messaging Server supports the Lightweight Directory Access Protocol (RFC 1777) for managing its user's information and for routing messages. Messaging Server interoperates with a wide variety of third-party directory tools and Netscape Directory Server. Messaging Server automatically creates, deletes, or changes the account when it receives an update. Messaging Server uses an account database provided by any LDAP-compliant directory server. IMAP4 is based on work by the University of Washington and is embodied in the RFC 1730 specification. It allows users to be disconnected from the main messaging system and still be able to process their mail. The specification allows for administrative controls for these disconnected users and for the resynchronization of the users message store once the user reconnects to the messaging system.

IMAP4 as an open standard does allow for the integration of security mechanisms for the client authentication to the messaging server. An encrypted messaging transport protocol is not part of the IMAP4 specification and has been developed to the S/MIME standard in Netscape Communicator.

Although the invention is preferably described herein with reference to the preferred embodiment, one skilled in the art will readily appreciate that other applications may be substituted for those set forth herein without departing from the spirit and scope of the present invention. Accordingly, the invention should only be limited by the claims included below.

1. A calendaring system method, the method comprising the steps of:
creating a frame set in which there are a plurality of visible frames and a plurality of invisible frames;
including a calendar event data that was requested from the server in said frame set;
transmitting at least one frame in said plurality of invisible frames with a JavaScript routine able to read said calendar event data and able to generate HTML-code for rendering events and interface elements;
generating HTML-code within one of said plurality of invisible frames that renders within one of said plurality of visible frames a user interface; and
calling said JavaScript routine to change said user interface in response to a user clicking-on a variety of links and controls rendered in said user interface;
wherein, a user interface is generated within a web client “on-the-fly” within a user's browser.

2. The method of claim 1, wherein:
the step of creating a frame set is instigated from a webserver and executed by said user's browser.

3. The method of claim 1, further comprising the steps of:
storing and maintaining a database of events and tasks at a webserver; and
including a selected and relevant portion of the database of events in the step of creating a frame set.

4. The method of claim 3, wherein:
the step of including is in-response to an event-data request sent from said user's browser to said webserver.

5. The method of claim 1, wherein:
the step of generating HTML-code within one of said plurality of invisible frames is a result of executing a particular JavaScript routine supplied by said webserver and hosted by said user's browser in one of said invisible frames.

6. The method of claim 1, further comprising the steps of:
inserting advertising for display in one of said visible frames.

7. The method of claim 6, further comprising the steps of:
sending advertising information for said display from a remote server that is independent of said webserver and a web-client.

8. A calendaring system, comprising:
a webserver having an Internet connection;
a web-client having a browser and network connection to said Internet;
an event database included in the webserver and providing for the storage and maintenance of appointment, calendar, task, and event information relevant to at least one user;
a JavaScript generator included in the webserver and providing for JavaScript routines targeted to execute in the web-client by said browser;
a frame-set generator included in the webserver and providing for a transmission of event data, HTML for frames, and JavaScript to the web-client and said browser;
a plurality of visible frames generated by the web-client and said browser and displayed to said user; and
a plurality of invisible frames generated by the web-client and said browser and not displayed to said user;
wherein said JavaScript routines are eventually hosted in at least one of the plurality of invisible frames and when executing produce HTML-code that is rendered in at least one of the plurality of visible frames.

9. The calendaring system of claim 8, wherein:
the plurality of visible frames constitute displays of user appointments and event calendars, and a user can interact with them to change calendar display formats and time periods.

10. The calendaring system of claim 8, wherein:
the web-client allows a user to initiate an event-data request that is answered by the webserver with said transmission of event data, HTML for frames, and JavaScript to the web-client and said browser.
